(19) United States
(12) Patent Application Publication
(10) Pub. No.: US 2013/0159510 A1
(43) Pub. Date: Jun. 20, 2013

(54) Event Correlation Between Protocol Layers in a Network Device

(71) Applicant: Christopher William Cahill, Northborough, MA (US)

(72) Inventor: Christopher William Cahill, Northborough, MA (US)

(73) Assignee: AWARE, INC., Bedford, MA (US)

(21) Appl. No.: 13/702,079

(22) PCT Filed: Jun. 16, 2011
(86) PCT No.: PCT/US11/40641

§ 371 Date: Feb. 26, 2013

Related U.S. Application Data
(60) Provisional application No. 61/355,868, filed on Jun. 17, 2010.

(51) Int. Cl. G06F 11/30

(52) U.S. Cl. CPC G06F 11/3003
USPC 709/224

(57) ABSTRACT

A system and method for correlating events between protocol layers of a protocol stack of a network device includes detecting, at a first protocol layer, an occurrence of a first event associated with one or more data units received by the network device over physical media. A first times-tamp is associated with the first event. At a second protocol layer, an occurrence of a second event associated with the one or more data units is detected The second protocol layer is at a higher protocol layer of a protocol stack than the first protocol layer. A second timestamp is associated with the second event. A determination is made whether there is a correlation between the first and second events based on the first and second timestamps. Causation of the second event at the second protocol layer may be attributable to the first event at the first protocol layer.

### RELATED APPLICATION

This application claims the benefit of U.S. Provisional Application Ser. No. 61/355,868, filed Jun. 17, 2010, titled “Error Correlation between Layers in a Networking Device,” the entirety of which provisional application is incorporated by reference herein.

### FIELD OF THE INVENTION

The invention relates generally to data processing. More specifically, the invention relates to error correlation between protocol layers of a protocol stack in a network device.

### BACKGROUND

Conventional communication networks transfer data blocks, also referred to herein as data units, frames, or packets, using a physical layer media between network devices or nodes. The communication between network devices is typically modeled in layers. For its network communications, each network device has a protocol stack, which refers to the stack of protocol layers in its protocol suite. The Open Systems Interconnection (OSI) model, for example, describes seven layers, with the physical layer being the lowest layer and the application layer being the highest. Abstract protocol layers above the physical layer perform various authentication, bridging, routing, and application services. When a network device sends a communication to another network device, the communication passes down through the layers of the protocol stack of the sending device and up through layers of the protocol stack of the receiving device. Each given layer communicates with either the next layer above or the next layer below that given layer. The protocol at each given layer corresponds to that set of rules followed in order provide the services of that given layer.

Because of problems with the physical media, data blocks can become corrupt during transmission. Network devices usually determine if a data block is bad by implementing error checking. Cyclic redundancy check (CRC) is one method for determining whether a data block is bad. The CRC uses overhead data to carry a code representing the information in the data block. When a network device receives a data block, the device processes the data using a CRC algorithm and calculates a resulting CRC. The resulting CRC is compared with a fixed length CRC that is attached to the incoming data block. If there is a mismatch, a CRC error is tabulated.

Depending on the service, corrupt data can degrade the quality of the application layer, or require a network operator to add additional data throughput capacity for resending data. If a data block is erred, the protocol layer processing the data block may discard the data block or transfer the data block to the next layer in the protocol stack, in effect propagating the error to a higher layer. Eventually, if correction of the data block does not occur, either by retransmission or by a more advanced form of error correction, the application using the data block will be affected. For example, on a television that receives video information over a data network, erred data will manifest itself as a display anomaly. However, not every error occurring at a higher layer is attributable to a physical or lower layer error. For instance, network congestion on a data system delivering scheduled data blocks may corrupt application layers despite transmission over an error-free physical layer.

### SUMMARY

In one aspect, the invention features a method for correlating events occurring at different hierarchical protocol layers of a protocol stack of a network device. Detected at a first protocol layer of the network device is an occurrence of a first event associated with one or more data units received by the network device over physical media. A first timestamp is associated with the first event. At a second protocol layer of the network device, an occurrence of a second event is detected. The second event is associated with the one or more data units received over the physical media. The second protocol layer is at a higher protocol layer of a protocol stack of the network device than the first protocol layer. A second timestamp is associated with the second event. It is determined whether there is a correlation between the first and second events based on the first and second timestamps.

In another aspect, the invention features a computer program product for correlating errors between hierarchical protocol layers of a protocol stack of a network device. The computer program product comprises a computer readable storage medium having computer readable program code embodied therewith. The computer readable program code comprises computer readable program code that, if executed, detects at a first protocol layer of a network device, an occurrence of a first event associated with one or more of a plurality of data units received by the network device over physical media, computer readable program code that, if executed, associates a first timestamp with the first event, and computer readable program code that, if executed, detects at a second protocol layer of the network device, an occurrence of a second event associated with the one or more data units received over the physical media. The second protocol layer is at a higher layer of a protocol stack of the network device than the first protocol layer. The computer readable program code further includes computer readable program code that, if executed, associates a second timestamp with the second event, and computer readable program code that, if executed, determines whether there is a correlation between the first and second events based on the first and second timestamps.

In still another aspect, the invention features an system for correlating errors between hierarchical network layers of a protocol stack of a network device. The system comprises a processor capable of running computer readable program code stored in memory. If executed, the computer readable program code detects at a first protocol layer of the network device, an occurrence of a first event associated with one or more data units received by the network device over physical media, associates a first timestamp with the first event, detects at a second protocol layer of the network device higher than the first protocol layer, an occurrence of a second event associated with the one or more data units received over the physical media, associates a second timestamp with the second event, and determines whether there is a correlation between the first and second events based on the first and second timestamps.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of a communication network environment including a network device in communication with a second network device.

FIG. 2 is a block diagram of an embodiment of a protocol stack.

FIG. 3 is a block diagram of embodiments of tables used to store event entries and correlated-event entries.

FIG. 4 is a flow diagram of an embodiment of a process for correlating events occurring at multiple protocol layers.

FIG. 5 is a flow diagram of an embodiment of a process for calibrating time systems of multiple protocol layers.

### DETAILED DESCRIPTION

Network devices described herein implement a mechanism for correlating events that occur at lower-level protocol layers of a protocol stack with events that occur at higher-level protocol layers. The mechanism enables diagnostics for understanding errors encountered at the higher layers, either by finding a root cause in a lower layer event or by determining that the lower layers are error free and redirecting the search for root cause elsewhere.

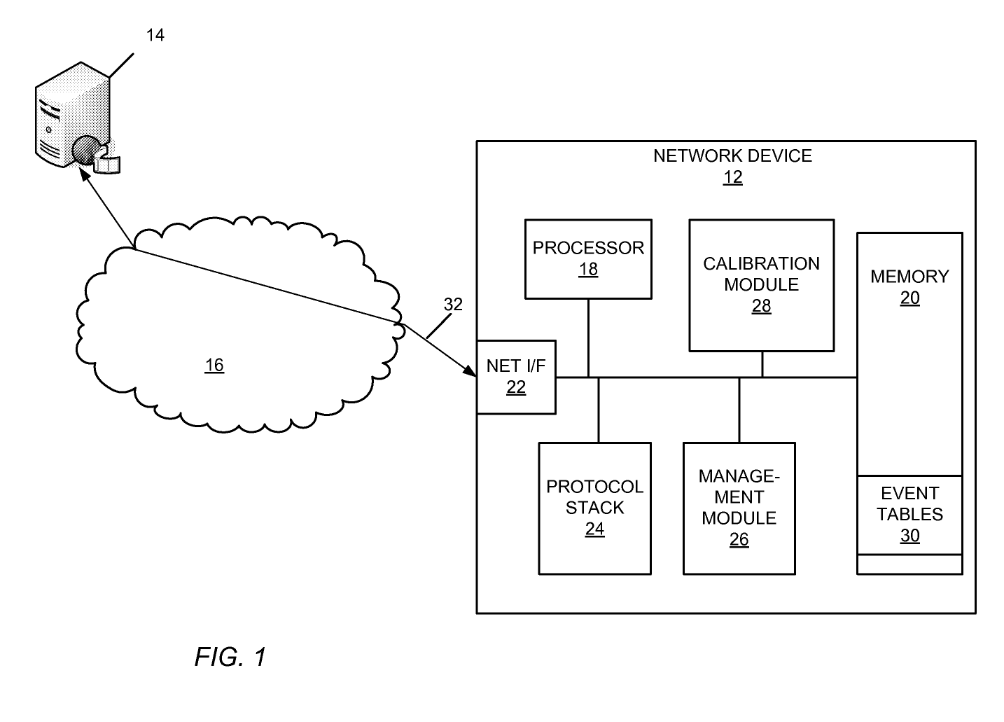

FIG. 1 shows an embodiment of an oversimplified communication network environment 10 including a first network device 12 in communication with a second network device 14 over a network 16. Embodiments of the network 16 include, but are not limited to, local-area networks (LAN), metro-area networks (MAN), and wide-area networks (WAN), such as the Internet or World Wide Web. The network device 14 represents a data source, such a media server used, for example, in Internet Protocol Television (IPTV), voice over IP (VoIP), video-on-demand (VoD) applications. The network device 12 can connect to the network device 14 over the network 16 through one of a variety of wired or wireless connections such as standard telephone lines, digital subscriber line (DSL), coaxial cable, satellite, cellular mobile, LAN or WAN links (e.g., T1, T3), broadband connections (Frame Relay, ATM), and wireless connections (e.g., 802.11(a), 802.11(b), 802.11(g), 802.11(n)).

The network device 12 includes a processor 18, memory 20, a network interface 22, a protocol stack 24, a management module 26, and a calibration module 28. The memory 20 can include non-volatile (i.e., persistent) computer storage media, such as read-only memory (ROM), and volatile computer storage media, such as random-access memory (RAM). Stored within the RAM are program code and data. Program code includes, but is not limited to, application programs, program modules, such as the management module 26 and calibration module 28, program code for the various layers of the protocol stack 24, and an operating system. In addition, the memory 20 stores event hash tables (EHTs) 30, described further in connection with FIG. 3. The network interface 22 provides access to the network 16 over physical media 32. The physical media 32 can be wired (e.g., cable) or wireless. Example implementations of the network device 12 include modems (DSL and cable), test equipment, remote gateway (with DSL), bridge routers, set-top boxes, satellite receivers, mobile handsets, networked appliances.

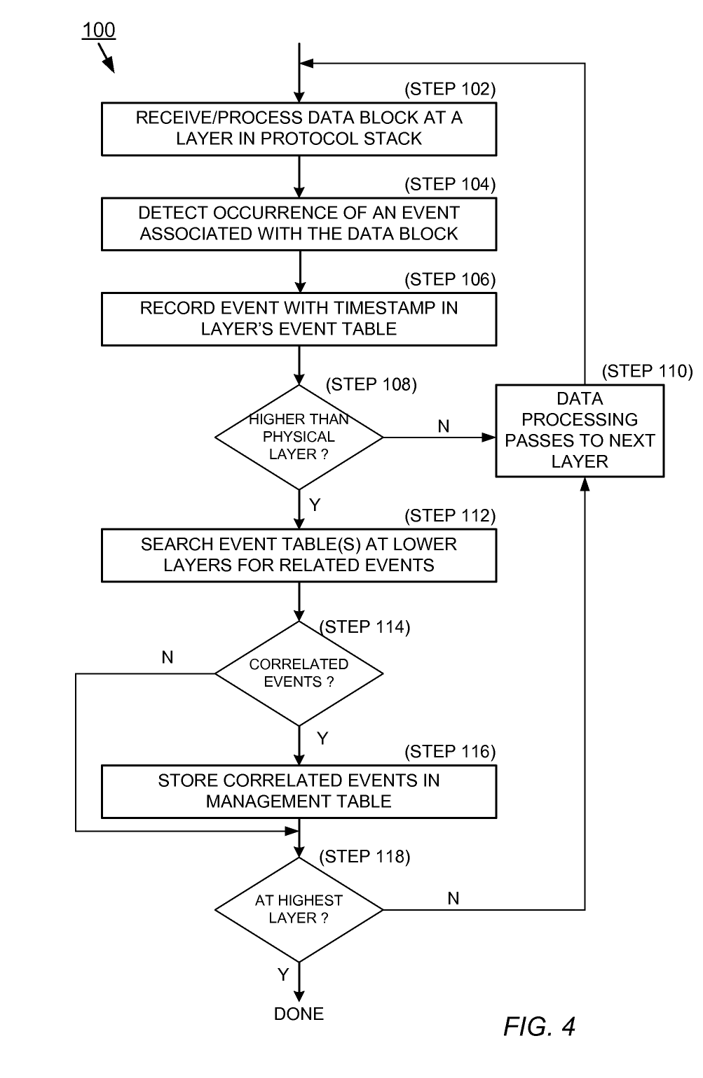

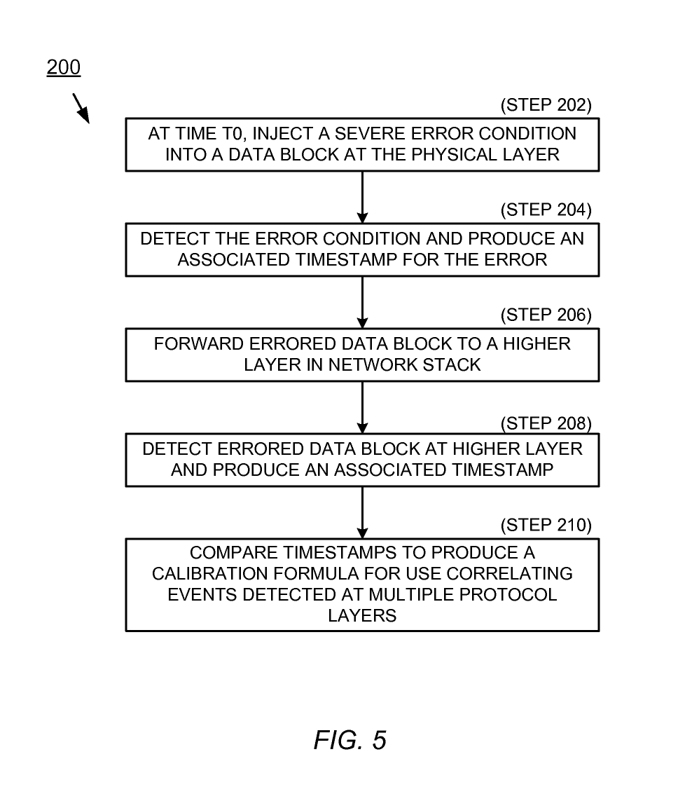

In brief overview, the protocol stack 24 provides the various levels of services for processing data received over the network, the management module 26 manages the event-correlation processes as described in more detail in connection with FIG. 4, and the calibration module 28 calibrates the time systems of the different protocol layers so that correlations may be found between timestamps, as described in more detail in connection with FIG. 5. As described herein, an event correlation can occur between any two layers of the protocol layer stack. In general, events include, but are not limited to, the detection of errors (e.g., CRC, missing packets) and actions taken at any layer in response to detected errors (e.g., requesting retransmission, concealing, modifying, or discarding the errored data block). In one embodiment, the management module 26 examines anomalies that occur at the application layer and determines which protocol layer or layers of the network device previously detected the problem by looking for previously recorded events with a correlated timestamp, the lowest layer at which detection occurs corresponding to the earliest known indication of a data processing problem and to the possible root cause of the problem at the application layer by virtue of propagation up through the protocol stack.

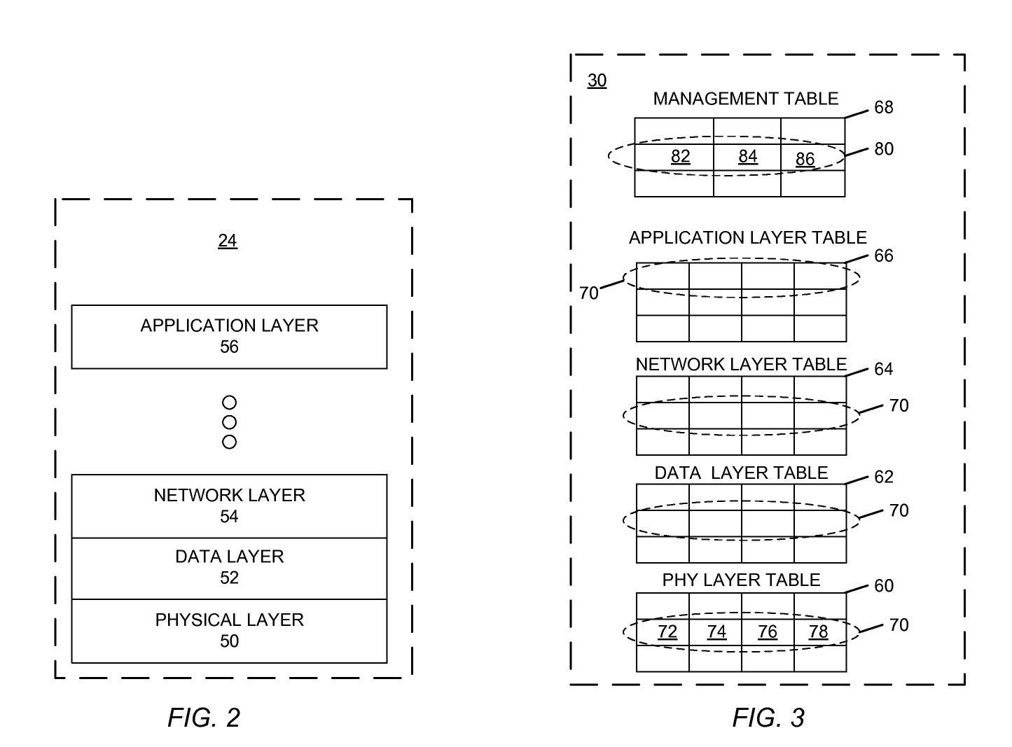

FIG. 2 shows an example of a hierarchical protocol stack 24 that can be used by the network device 12 when communicating with other network devices over the network 16. This example of a protocol stack 24 includes a physical layer 50, a data layer 52, a network layer 54, and an application layer 56. At the lowest layer is the physical layer 50, which is responsible for sending and receiving bits across the network 16, and relates generally to the physical, electrical, and cable matters involved with making a network connection. At the highest layer of the stack is the application layer 56. The roles of the protocol layers are generally well known in the art. Other embodiments can have more, fewer, or different layers than the layers shown.

FIG. 3 shows an embodiment of the event hash tables 30 managed by the management module 26. In one embodiment, each layer of the protocol stack 24 has an associated table. In this embodiment, there is a physical layer table 60, a data layer table 62, a network layer table 64, and an application layer table 66. In other embodiments, only layers of interest have associated tables. Each entry 70 in one of these tables contains information about an event detected at that corresponding protocol layer. Example types of information that can be recorded in an entry include an event ID 72, a layer ID 74, a timestamp 76, and, optionally, a severity indicator 78. The event ID 72 provides a mechanism for uniquely identifying a given event. The layer ID 74 identifies the protocol layer at which the event occurred. The timestamp 76 identifies the time of occurrence of the event (in the time system of that protocol layer). The severity indicator 78 is an action code that signifies the corrective action taken, if any, in response to the detected event. Examples of such actions include, but are not limited to, discarding a data block, modifying the data block, transferring the data block as is to the next layer, and requesting retransmission of the errored data block. Although in FIG. 3 the tables are shown separately, they can be stored contiguously in the memory 20, with the start and end addresses of each table being the mechanism for separating the tables, or stored randomly in memory, with the layer ID being used to distinguish among the tables. In addition, other types of data structures, other than tables, can be used to record events and information about the events.

A management table 68 keeps records of correlated events. Each entry 80 in the management table is, in effect, a link between an entry 70 in one table of a first layer and an entry 70 in a table of a second layer. Each entry 80 can be implemented as a pair of pointers 82, 84, each pointing to a different one of the two correlated event entries (in two different tables), and an optional timestamp 86 for when the event correlation was recorded. The management table can be useful for diagnostic purposes, for example, by providing a historical log of correlated events.

FIG. 4 shows an embodiment of a process 100 for correlating events occurring at a higher layer in the protocol stack with events occurring at the physical layer. Although described primarily in connection with the physical layer, the process 100 applies to any two layers of the protocol stack. At step 102, one or more data blocks are received and processed at a protocol layer. At that layer in the protocol stack, an event is detected (at step 104), for example, a failed CRC or a missing packet. The event is recorded (step 106) with an associated timestamp in the event hash table associated with that protocol layer. The protocol layer that detects the event may take a corrective action. For instance, IPTV systems can conceal errors using various video-processing techniques. Although concealment may result in the data block not being used by the application layer, the effect to the end-user experience is negligible. A severity indicator can be stored with the recorded entry to indicate the impact of the event on the data unit by, for example, indicating whether the error caused the packet to be retransmitted, dropped, corrected, or amended in a way to still be usable by the application layer. The data processing proceeds (step 110) to the next higher protocol layer if it is the physical layer that has detected this event. Otherwise, the management module 26 searches (step 112) the event tables of those layers below the layer that has detected this event, looking for related entries based on the present timestamp associated with this event. A related previously stored entry will have a timestamp that differs from the current timestamp in accordance with a predetermined formula (taking into account any differences in the time systems of the protocol layers and jitter in each of the time systems).

If, at step 114, the search of the table(s) does not find a correlating event, this is an indication that the source of the problem experienced by the event-detecting layer is not a lower layer, such as the physical layer. Accordingly, diagnosis of the problem can focus elsewhere, for example, at network congestion. If not currently at the highest layer (step 118), the data processing continues (step 110) with the next layer in the protocol stack. Alternatively, if a correlation is found, the management module 26 stores (step 116) an entry in the management table 68 to provide a record of the correlated events. More than one correlation may be found; for example, an event detected at the application layer 56 may correlate with an event detected at the data layer 52 and an event detected at the physical layer 50. In this example, the detection at the physical layer corresponds to the earliest known detection of a problem and highlights the physical layer as the potential source of the problem.

For accurate and reliable event correlation, the protocol layers of the network device preferably have calibrated time systems. FIG. 5 shows an embodiment of a process 200 for calibrating the time systems of different protocol layers. Although the process 200 is described herein with reference to the application and physical layers, timestamp calibration can be performed between any two layers of the protocol layer stack. At step 202, the calibration module injects a severe error condition in real time (time t0) into one or more data blocks being received at the physical layer. The severe error condition is designed to induce errors at least at those particular protocol layers (here, e.g., the physical and application layers) for which time calibration is being performed. The physical layer detects (step 204) the error condition and, in response, causes a prescribed event, for example, discards an errored data block or forwards the errored data block, as is, up the protocol stack. The calibration module records (step 206) an associated timestamp for time t0 in the EHT 60 associated with the physical layer 50.

The processing of the one or more data blocks passes upward through the protocol stack to the application layer 56 (each of the intervening protocol layers may or may not detect and record errors in their own EHTs). The application layer detects (step 208) an error condition at time t1 caused by the injected severe error. The calibration module 28 associates (step 210) a timestamp with this detected error condition. The calibration module compares (step 212) this application layer timestamp with the timestamp entry for the physical layer to characterize the offset between the two timestamps, and produces (step 214) a calibration formula for use by the management module when searching through event hash tables in search for correlated timestamps between these two particular layers (the calibration formula can be different for each different pair of protocol layers). For instance, in an ideal timing system with fixed delay but no jitter, the offset between correlated timestamps is a fixed delta value. In a timing system with jitter, the offset between correlated timestamps is a window or range of values.

The above-described methods and systems and can be implemented in a software module, a software and/or hardware testing module, a telecommunications test device, a DSL modem, an ADSL modem, an xDSL modem, a VDSL modem, a linecard, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: xDSL, CDSL, ADSL2, ADSL2+, VDSL1, VDSL2, HDSL, DSL Lite, IDSL, RADSL, SDSL, UDSL, or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to this invention.

As will be appreciated by one skilled in the art, aspects of the present invention may be embodied as a system, method, or computer program product. Accordingly, aspects of the present invention may take the form of an entirely hardware embodiment (e.g., standard logic circuits or VLSI design), an entirely software embodiment (including firmware, resident software, micro-code, etc.) or an embodiment combining software and hardware aspects. All such forms may be generally referred to herein as a “system”. Furthermore, aspects of the present invention may take the form of a computer program product embodied in one or more computer readable storage medium(s) having computer readable program code embodied thereon.

A computer readable storage medium may be any tangible medium that can contain, or store a program for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium include, but are not limited to, the following: a portable computer diskette, a hard disk, a random access memory (RAM), a read-only memory (ROM), an erasable programmable read-only memory (EEPROM, EPROM, Flash memory), an optical fiber, a portable compact disc read-only memory (CD-ROM), an optical storage device, a magnetic storage device, or any suitable combination of the foregoing. Program code embodied on a computer readable storage medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java®, CGI script, Smalltalk, C++ or the like and conventional procedural programming languages, such as the “C” programming language or similar programming languages.

Aspects of the present invention are described herein with reference to flowchart illustrations and block diagrams of methods, apparatus (systems), and computer program products in accordance with embodiments of the invention. Each block of the flowchart illustrations and block diagrams, and combinations of blocks in the flowchart illustrations and block diagrams can be implemented by computer program instructions.

Computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions, acts, or operations specified in the flowchart and block diagram block. Computer program instructions may also be stored in a computer readable storage medium that can direct a computer, other programmable data processing apparatus, or other devices to function in a particular manner, such that the instructions stored in the computer readable medium produce an article of manufacture including instructions which implement the function, act, or operation specified in the flowchart and block diagram block.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions, acts, or operations specified in the flowchart or diagram block.

The flowchart and block diagrams in the FIGS. illustrate the architecture, functionality, and operation of possible implementations of systems, methods, and computer program products according to various embodiments of the present invention. In this regard, each block in the flowchart or block diagrams may represent a module, segment, or portion of program code, which comprises one or more executable instructions for implementing the specified logical function(s). The functions noted in the blocks may occur out of the order noted in the FIGS. For example, two blocks shown in succession may be executed substantially concurrently, or the blocks may sometimes be executed in the reverse order, depending upon the functionality involved. In addition, each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While one or more example embodiments described herein discuss various components of the system as being collocated, it should be appreciated that various components may be located separately (e.g., at distant portions of a distributed network, such as a telecommunications network and/or the Internet or within a dedicated communications network). Thus, it should be appreciated that various components of the system may be combined into one or more devices or collocated on a particular node of a distributed network, such as a telecommunications network.

While the invention has been shown and described with reference to specific example embodiments, it should be appreciated that individual aspects of the invention can be separately claimed and one or more of the features of the various embodiments can be combined. In addition, it should be understood by those skilled in the art that various changes in form and detail may be made therein without departing from the spirit and scope of the invention as defined by the following claims.

What is claimed is:

1. A method for correlating events occurring at different hierarchical protocol layers of a protocol stack of a network device, comprising:
detecting, at a first protocol layer of the network device, an occurrence of a first event associated with one or more data units received by the network device over physical media;
associating a first timestamp with the first event;
detecting, at a second protocol layer of the network device, an occurrence of a second event associated with the one or more data units received over the physical media, the second protocol layer being at a higher protocol layer of a protocol stack of the network device than the first protocol layer;
associating a second timestamp with the second event; and
determining whether there is a correlation between the first and second events based on the first and second timestamps.

2. The method of claim 1, further comprising attributing causation of the second event at the second protocol layer to the occurrence of the first event at the first protocol layer when the first protocol layer is a lowest layer in the protocol stack at which a correlated event is detected.

3. The method of claim 1, further comprising associating a severity indicator with the first timestamp.

4. The method of claim 1, wherein the first protocol layer is any one of the protocol layers in the protocol stack of the network device and the second protocol layer is any other of the protocol layers of the protocol stack of the network device.

5. The method of claim 1, wherein the first protocol layer is a physical layer of the protocol stack and the second protocol layer is an application layer of the protocol stack.

6. The method of claim 1, further comprising calibrating a time system of the first protocol layer with respect to a time system of the second protocol layer to derive a calibration formula used when determining whether there is a correlation between the first and second events based on the first and second timestamps.

7. The method of claim 6, wherein the calibration formula includes a fixed value offset.

8. The method of claim 6, wherein the calibration formula includes a range-of-values offset.

9. The method of claim 1, wherein determining whether there is a correlation between the first and second events based on the first and second timestamps includes searching through event entries recorded in a table associated with the first protocol layer of the network device for an event entry with a timestamp that matches the second timestamp offset by a predetermined calibration formula.

10. A computer program product for correlating errors between hierarchical protocol layers of a protocol stack of a network device, the computer program product comprising:
a computer readable storage medium having computer readable program code embodied therewith, the computer readable program code comprising:
computer readable program code that, if executed, detects at a first protocol layer of a network device, an occurrence of a first event associated with one or more of a plurality of data units received by the network device over physical media;
computer readable program code that, if executed, associates a first timestamp with the first event;
computer readable program code that, if executed, detects at a second protocol layer of the network device, an occurrence of a second event associated with the one or more data units received over the physical media, the second protocol layer being at a higher layer of a protocol stack of the network device than the first protocol layer;
computer readable program code that, if executed, associates a second timestamp with the second event; and
computer readable program code that, if executed, determines whether there is a correlation between the first and second events based on the first and second timestamps.

11. The computer program product of claim 10, further comprising computer readable program code that, if executed, attributes causation of the second event at the second protocol layer to the occurrence of the first event at the first protocol layer when the first protocol layer is a lowest layer in the protocol stack at which a correlated event is detected.

12. The computer program product of claim 10, further comprising computer readable program code that, if executed, associates a severity indicator with the first timestamp.

13. The computer program product of claim 10, wherein the first protocol layer is any one of the protocol layers in a protocol stack of the network device and the second protocol layer is any other of the protocol layers of the protocol stack of the network device.

14. The computer program product of claim 10, wherein the first protocol layer is a physical layer of a protocol stack and the second protocol layer is an application layer of the protocol stack.

15. The computer program product of claim 10, further comprising computer readable program code that, if executed, calibrates a time system of the first protocol layer with respect to a time system of the second protocol layer to derive a calibration formula used when determining whether there is a correlation between the first and second events based on the first and second timestamps.

16. The computer program product of claim 15, wherein the calibration formula includes a fixed value offset.

17. The computer program product of claim 15, wherein the calibration formula includes a range-of-values offset.

18. The computer program product of claim 10, wherein the computer readable program code that determines whether there is a correlation between the first and second events based on the first and second timestamps includes computer readable program code that searches, if executed, through event entries recorded in a table associated with the first protocol layer of the network device for an event entry with a timestamp that matches the second timestamp offset by a predetermined calibration formula.

19. A system for correlating errors between hierarchical network layers of a protocol stack of a network device, comprising:
a processor capable of running computer readable program code stored in memory, which, if executed, detects at a first protocol layer of the network device, an occurrence of a first event associated with one or more data units received by the network device over physical media, associates a first timestamp with the first event, detects at a second protocol layer of the network device higher than the first protocol layer, an occurrence of a second event associated with the one or more data units received over the physical media, associates a second timestamp with the second event, and determines whether there is a correlation between the first and second events based on the first and second timestamps.

20. The system of claim 19, wherein the computer readable program code further comprises computer readable program code that, if executed, attributes causation of the second event at the second protocol layer to the occurrence of the first event at the first protocol layer when the first protocol layer is a lowest layer in the protocol stack at which a correlated event is detected.

21. The system of claim 19, wherein the computer readable program code further comprises computer readable program code that, if executed, associates a severity indicator with the first timestamp.

22. The system of claim 19, wherein the first protocol layer is any one of the protocol layers in a protocol stack of the network device and the second protocol layer is any other of the protocol layers of the protocol stack of the network device.

23. The system of claim 19, wherein the first protocol layer is a physical layer of a protocol stack and the second protocol layer is an application layer of the protocol stack.

24. The system of claim 19, wherein the computer readable program code further comprises computer readable program code that, if executed, calibrates a time system of the first protocol layer with respect to a time system of the second protocol layer to derive a calibration formula used when determining whether there is a correlation between the first and second events based on the first and second timestamps.

25. The system of claim 21, wherein the calibration formula includes a fixed value offset.

26. The system of claim 21, wherein the calibration formula includes a range-of-values offset.

27. The system of claim 19, wherein the computer readable program code that determines whether there is a correlation between the first and second events based on the first and second timestamps includes computer readable program code that searches, if executed, through event entries recorded in a table associated with the first protocol layer of the network device for an event entry with a timestamp that matches the second timestamp offset by a predetermined calibration formula.

28. (canceled)

29. (canceled)

30. (canceled)
